(19) United States
(12) Patent Application Publication
(10) Pub. No.: US 2009/0098812 A1
(43) Pub. Date: Apr. 16, 2009

(54) GUARD ANTI-ROTATION LOCK

(75) Inventors: Cornelius Boeck, Kirchheim (DE); Joachim Schadow, Leinfelden-Echterdingen (DE); Sinisa Andrasic, Schoenaich (DE)

Correspondence Address: MICHAEL J. STRIKER, 103 EAST NECK ROAD, HUNTINGTON, NY, 11743, US

(73) Assignee: Robert Bosch GMBH, Stuttgart (DE)

(21) Appl. No.: 12/282,828

(22) PCT Filed: Nov. 9, 2007
(86) PCT No.: PCT/EP2007/062134

§ 371 Date: Sep. 12, 2008

(30) Foreign Application Priority Data
Nov. 13, 2006 (DE) 10 2006 053 305.4

(51) Int. Cl. B24B 23/02; B25F 5/00; B23Q 11/00; B24B 55/05

(52) U.S. Cl. 451/352; 451/451

(57) ABSTRACT

The invention relates to a protective hood anti-rotation lock for a portable power tool (12a-f), especially for an angle grinder, for providing anti-rotational locking between the portable power tool and a protective hood unit (14a-f). According to the invention, the protective hood anti-rotation lock has a non-positive unit (16a-f) which is provided for anti-rotational locking of the portable power tool (12a-f) and the protective hood unit (14a-f) in the event of a tool (18a-f) breakage.

### RELATED ART

The present invention is directed to a guard anti-rotation lock device according to the preamble of claim 1.

An angle grinder with an adjustable guard is made known in EP 812 657 A1. In that case, the guard is adjustable in a rotating manner on a connection piece of a flange of the angle grinder, and is supported such that it may be detachably attached using a single form-fit locking means. The spindle of the angle grinder passes through the center of the flange. A cutting disk and/or grinding disk are/is installed on the free end of the spindle in a clampable, rotationally drivable manner for cutting and machining work pieces, which are partially enclosed by the guard. The guard must be positioned in a rotationally adjustable manner on the hand-held power tool such that the region of the grinding disk that faces the user is enclosed by the guard. At the same time, a region of the grinding disk that points away from the user extends past the flange, radially relative to the region of engagement with the work piece.

### ADVANTAGES OF THE INVENTION

The present invention relates to a guard anti-rotation lock device for a hand-held power tool, in particular for an angle grinder, which is provided to prevent rotation between the hand-held power tool and a guard unit.

It is provided that the anti-rotation lock device includes a non-positive connection unit, which is provided to prevent rotation between the hand-held power tool and the guard unit if a tool should burst. The guard unit is preferably provided to protect an operator—during regular operation of the hand-held power tool—from a tool, in particular from a disk-shaped, rotatably drivable tool, and/or from machining residue that is slung in the direction of the operator, and it is attached to the hand-held power tool in a working position. A “non-positive connection unit” refers, in particular, to a unit that is provided to establish a non-positive connection—that acts in the circumferential direction—between the guard unit and the hand-held power tool, and which is designed—when in an anti-rotation lock position between the guard unit and the hand-held power tool—to absorb forces of an outwardly-slung tool piece that could occur if a tool should burst. To attain an anti-rotation lock of the guard unit on the hand-held power tool, the guard unit, which is attached to the hand-held power tool, may be moved into the anti-rotation lock position by absorbing forces of impulses and/or forces of outwardly-slung pieces of the burst tool. “Provided” is intended to mean, in particular, specially equipped and/or designed. Due to the inventive design of the guard anti-rotation lock device, it is possible to effectively protect an operator of the hand-held power tool from a tool that rotates during operation of the hand-held power tool, and, in particular, from pieces of the tool that are slung in the direction of the operator if the tool becomes damaged, e.g., if the tool should burst.

In addition, according to the present invention, the non-positive connection unit is provided to establish a non-positive connection between the hand-held power tool and the guard unit by changing at least one shape parameter of a component of the hand-held power tool and/or the guard unit. As a result, advantageously, an increased frictional force may be attained between the guard unit and the hand-held power tool, in particular along contact surfaces for attaching the guard unit to the hand-held power tool if the tool should burst, thereby generating an additional force for fixing the guard unit in position. This may be attained in a particularly advantageous manner when the non-positive connection unit includes at least one non-positive connection element, which is provided to change the shape parameter of the hand-held power tool and/or the guard unit. Preferably, the shape parameter includes a cross-sectional area of a receiving unit of the hand-held power tool, and/or a diameter of a clamping band of the guard unit, and/or further shape parameters that appear reasonable to one skilled in the technical art. A “cross-sectional area of a receiving unit” refers, in particular, to a surface to be enclosed in a circumferential direction by the clamping band in order to attain a non-positive connection between the hand-held power tool and the guard unit.

It is also provided that the non-positive connection element is movably supported on the hand-held power tool and/or the guard unit, thereby making it possible to change the shape parameter using a simple design, in particular if a tool should burst.

If, in addition, the non-positive connection element is movable—together with the guard unit—into an anti-rotation lock position if a tool should burst, it is advantageously possible to change the shape parameter by changing the position—in particular the anti-rotation lock position—of the non-positive connection element. In addition, the energy of a piece of a burst tool that is transferred to the guard may be advantageously used to change the position of the non-positive connection element. An “anti-rotation lock position” refers, in particular, to a position of the guard unit relative to the hand-held power tool in which the guard unit is oriented opposite to a rotation, in particular a direction of rotation of the tool on the hand-held power tool, in particular on a receiving flange.

In an advantageous refinement of the present invention, it is provided that the non-positive connection unit includes a guide element in which the non-positive connection element is movably supported, thereby making it possible to realize a particularly specific motion into an anti-rotation lock position, and to realize a low-wear motion of the non-positive connection element.

Particularly advantageously, the non-positive connection element may be moved—together with the guard unit—into an anti-rotation lock position when the non-positive connection element is provided to be coupled to the guard unit in an at least partially form-fit or non-positive manner. In this context, “couplable” refers, in particular, to a driving—due to an at least partial form-fit connection and/or non-positive connection—of the non-positive connection element when a guard unit that is attached to the hand-held power tool rotates from a working position and into the anti-rotation lock position. The guard unit is rotated from the working position and into the anti-rotation lock position due to a transfer of force and/or a transfer of an impulse from a piece of a tool that has burst to the guard unit.

Particularly advantageously, the non-positive connection element is designed as a rolling element, and/or an eccentric element, and/or a wedge element, and/or a non-positive element designed as a ramp in a circumferential direction, and/or any other non-positive connection elements that appear reasonable to one skilled in the technical art. As a result, it is advantageously possible to obtain a rotational driving with the guard unit and/or a change to a shape parameter using a simple design. The term “circumferential direction” is intended to mean, in particular, a direction that is oriented essentially parallel to a direction of rotation of the tool during operation of the hand-held power tool and/or when the guard unit is in an installed state on the hand-held power tool.

When the wedge element also includes a thread that enables attachment to a receiving unit of the hand-held power tool, it is possible to attain—using a simple design—a change in shape of the receiving unit, in particular a receiving flange of the receiving unit, against which the guard unit bears in a state in which it is attached to the hand-held power tool, by widening the receiving unit to attain an anti-rotation lock position via a non-positive connection, if a tool should burst.

In an alternative embodiment of the present invention, a hand-held power tool system with a hand-held power tool, in particular an angle grinder, a guard unit, and a guard anti-rotation lock device are provided, in which case the guard anti-rotation lock device includes a non-positive connection unit, which is provided to prevent rotation between the hand-held power tool and the guard unit if a tool should burst. As a result, it is possible to effectively protect an operator of the hand-held power tool from a tool that rotates during operation of the hand-held power tool, and/or, in particular, from pieces of the tool that are slung in the direction of the operator if the tool becomes damaged, e.g., if the tool should burst. To realize an anti-rotation lock of the guard unit on the hand-held power tool, the guard unit, which is attached to the hand-held power tool, may be moved into the anti-rotation lock position by absorbing impulses and/or forces of outwardly-slung pieces of the burst tool.

It is also provided that the non-positive connection unit includes at least one non-positive connection element, which is provided to change a shape parameter of the hand-held power tool and/or the guard unit. As a result, advantageously, an increased frictional force may be attained—via the non-positive connection element—between the guard unit and the hand-held power tool, in particular along contact surfaces for attaching the guard unit to the hand-held power tool, if the tool should burst, thereby generating an additional force for fixing the guard unit in position. Preferably, the shape parameter includes a cross-sectional area of a receiving unit of the hand-held power tool, and/or a diameter of a clamping band of the guard unit, and/or further shape parameters that appear reasonable to one skilled in the technical art.

When the hand-held power tool also includes a receiving unit in which the non-positive connection element is at least partially supported, it is possible to realize a particularly compact design of the non-positive connecting unit, at least to a certain extent, and/or if the non-positive connection element should become deformed due to a non-positive connection between the guard unit and the hand-held power tool if a tool should burst, then it is particularly easy to replace the non-positive connection element.

It is also provided that the receiving unit is designed slotted at least partially along a circumferential direction, thereby making it possible in a particularly advantageous manner to attain a reversible change in shape of the receiving unit, in particular a change of a cross-sectional area of the receiving unit. Slot-type openings in the receiving unit are preferably located on the receiving unit perpendicularly to the circumferential direction.

It is also provided that the receiving unit includes an intermediate ring on which the non-positive connection element is at least partially located, thereby making it possible to replace the non-positive connection element—using a simple design—if deformation should occur after a non-positive connection between the guard unit and the hand-held power tool if a tool should burst.

A simple design of the non-positive connection element for changing a shape parameter, in particular for reducing a diameter of a clamping band of the guard unit if a tool should burst, may be realized when the guard unit includes at least one closing unit, on which the non-positive connection element is at least partially located. The closing unit is preferably designed as a clamping closing unit and is provided to attach the guard unit to the hand-held power tool, the attachment advantageously taking place via a frictional connection between the clamping band and the hand-held power tool. Particularly advantageously, the non-positive connection element is located in the region of a closing element, e.g., in the region of a clamping screw, a clamping lever, and/or further closing elements that appear reasonable to one skilled in the technical art.

Particularly advantageously, the present invention includes a hand-held power tool for a rotating, preferably disk-shaped tool, with a machine housing that includes a flange and/or a machine neck, on which a guard—that is composed of sheet metal in particular—is detachably clampable in order to cover the tool. The guard includes a guard body, which is composed of a circular, disk-shaped piece, in particular with an outer edge located at a right angle thereto, and with a central, circular recess, on the edge of which a guard connection piece and/or collar is formed and that includes an annular clamping band that may be tightened using a clamping means. An anti-rotation lock that acts between the machine neck and the guard is located between the guard and the machine neck and is designed as a profiled structure. The guard may be repeatedly coupled via the clamping band and/or the clamping means in its clamping position in a form-fit and/or non-positive manner with the machine neck, and is therefore capable of being fixed in a non-rotatable position and, to attain a release position, may be disengaged from the form-fit and/or non-positive connection, so that the guard may then be adjusted in a rotational manner.

### DRAWING

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

FIG. 1 shows an exploded view of an inventive hand-held power tool system,

FIG. 2 shows a guard anti-rotation lock device with a non-positive connection element designed as an eccentric element, in a schematic, partial cross-sectional view,

FIG. 3 shows a guard anti-rotation lock device with a non-positive connection element that is movably supported inside a guide element, in a schematic, partial cross-sectional view,

FIG. 4 shows a guard anti-rotation lock device with a non-positive connection element designed as an eccentric element in the region of a closing unit of a guard unit, in a schematic, partial cross-sectional view,

FIG. 5 shows a guard anti-rotation lock device with a non-positive connection element designed as a wedge element, in a schematic, partial cross-sectional view,

FIGS. 6a, 6b show a guard anti-rotation lock device with a wedge element having an alternative design to that shown in FIG. 5, in a schematic view from the top (FIG. 6a), and in a cross-sectional view (FIG. 6b), and

FIGS. 7a, 7b show a guard anti-rotation lock device with a non-positive connection element designed as an intermediate ring, which is coupled to a guard unit in a non-positive manner (FIG. 7a) and in a form-fit manner (FIG. 7b), in a schematic, partial cross-sectional view.

### DESCRIPTION OF THE EXEMPLARY EMBODIMENTS

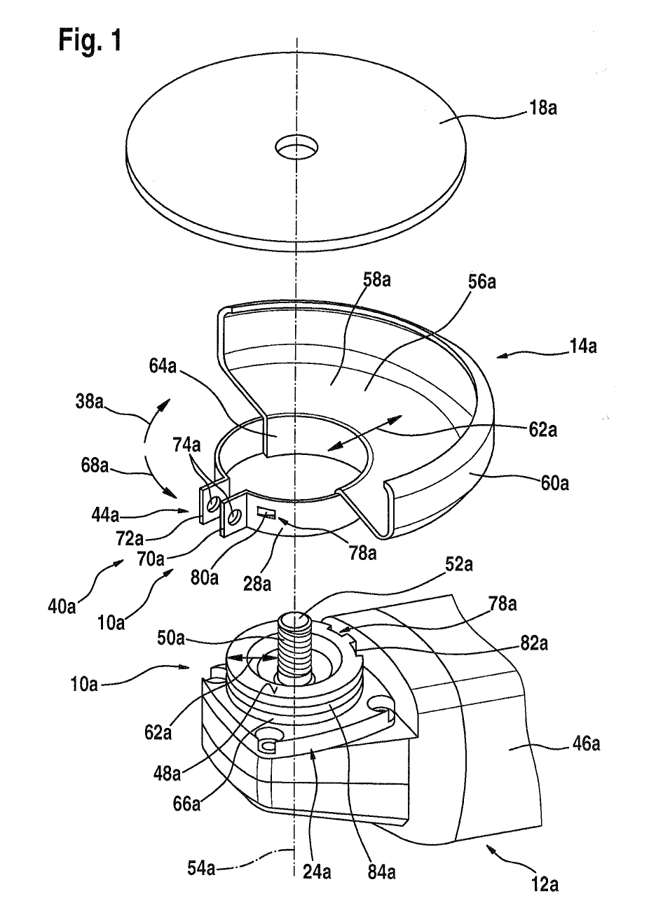

FIG. 1 shows a hand-held power tool system 40a with a hand-held power tool 12a designed as an angle grinder and shown only partially here, and with a guard unit 14a and a guard anti-rotation lock device 10a. Hand-held power tool 12a includes a hand-held power tool housing 46a, and a receiving unit 24a for receiving guard unit 14 and/or a tool 18a designed as a cutting disk, receiving unit 24a being screwed together with hand-held power tool housing 46a. A drive shaft 50a extends out of receiving unit 24a on a side 48a facing away from hand-held power tool housing 46a. Drive shaft 50a is connectable at its free end 52a with disk-shaped tool 18a and is rotationally drivable around an axis 54a. Guard unit 14a includes a guard 56a and a closing unit 44a. When hand-held power tool system 40a is in an installed state, guard 56a extends around an angular range of tool 18a of approximately 180° and, to this end, includes a semi-disk shaped guard body 58a and a guard edge 60a, which is initially oriented perpendicularly to semi-disk shaped body 58a and is finally oriented parallel to semi-disk shaped guard body 58a, inwardly in a radial direction 62a.

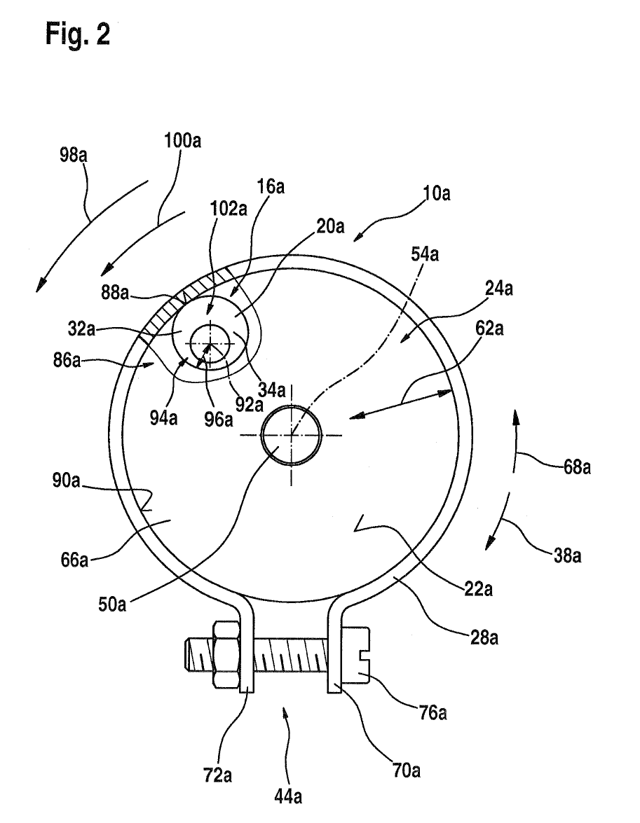

Guard unit 56a also includes a guard collar 64a, which is oriented essentially perpendicularly to semi-disk shaped guard body 58a. Guard collar 64a is enclosed outwardly in radial direction 62a by a clamping band 28a of closing unit 44a. Guard collar 64a and clamping band 28a are interconnected via a welded connection. Guard collar 64a—together with clamping band 28a—is provided to attach guard unit 14a to hand-held power tool 12a and/or to receiving unit 24a, which includes a cylindrical receiving flange 66a for this purpose. Along a circumferential direction 38a, 68a of clamping band 28a, clamping band 28a includes two end regions 70a, 72a in a region that faces away from guard 56a and extends outwardly in radial direction 62a. End regions 70a, 72a each include a recess 74a, through which a closing element 76a —designed as a clamping screw—of closing unit 44a extends (see FIG. 2). The clamping screw may be fastened in recesses 74a of the clamping band using a nut. Guard 56a is attached in a working position to receiving unit 24a and/or on receiving flange 66a via closing unit 44a using a frictional connection between guard collar 64a and clamping band 28a and receiving flange 66a, so that guard unit 14a is positioned in a non-rotatable manner during regular operation of hand-held power tool 12a. In an alternative design of closing unit 44a, it is basically feasible to use—instead of the clamping screw—further closing elements, e.g., a clamping lever and/or form-fit elements, etc.

Hand-held power tool system 40a also includes a coding device 78a, which is provided to prevent tools 18a and/or tools 18a together with guard unit 14a from being installed on unsuitable hand-held power tools 12a. To this end, clamping band 28a includes a coding element 80a of coding device 78a, which is designed as a single piece with clamping band 28a. Coding element 80a is designed as a pressed-out region that extends inwardly in radial direction 62a and has a rectangular shape. Correspondingly, receiving flange 66a includes a coding element 82a of coding device 78a, which is designed as a recess into which coding element 80a of clamping band 28a may be inserted when guard unit 14a is installed on hand-held power tool 12a. After guard unit 14a has been inserted onto receiving unit 24a, guard unit 14a may be rotated into a working position. To this end, receiving flange 66a includes a groove 84a that extends in circumferential direction 38a, 68a, in which coding element 80a is guided when guard unit 14a is rotated into the working position.

FIG. 2 shows guard anti-rotation lock device 10a in FIG. 1 in greater detail. Guard anti-rotation lock device 10a is provided to prevent rotation between guard unit 14a and hand-held power tool 12a and/or receiving unit 24a during a breakdown of tool 18a, e.g., when a tool 18a bursts. To this end, guard anti-rotation lock device 10a includes a non-positive connection unit 16a, which is provided to prevent rotation—via a non-positive connection—between hand-held power tool 12a and guard unit 14a if a tool 18a should burst. A non-positive connection is established between hand-held power tool 12a and guard unit 14a by changing a shape parameter of a component of hand-held power tool 12a designed as a receiving flange 66a. The shape parameter is designed as a cross-sectional area 22a of receiving unit 24a and/or receiving flange 66a to be enclosed by clamping band 28a in circumferential direction 38a, 68a. Cross-sectional area 22a extends essentially perpendicularly to axis 54a of drive shaft 50a. To this end, receiving unit 24a includes a non-positive connection element 20a of non-positive connection unit 16a, which is provided to change cross-sectional area 22a of receiving flange 66a.

To change cross-sectional area 22a, non-positive connection element 20a is designed as a cylindrical rolling element 32a, and it is movably supported in receiving flange 66a in an edge region 86a of receiving flange 66a located outwardly in radial direction 62a. Non-positive connection element 20a couples in a non-positive manner to clamping band 28a and/or guard collar 64a of guard unit 14a. A side 88a of rolling element 32a that points outwardly in radial direction 62a when guard unit 14a is in an installed working position on hand-held power tool 12a bears against a surface 90a—that faces inwardly in radial direction 62a—of clamping band 28a and/or of guard collar 64a of guard unit 14a. In addition, non-positive connection element 20a is designed as an eccentric element 34a, and it is supported in receiving flange 66a such that it may rotate around a rotation axis 92a, which is oriented essentially parallel to axis 54a of drive shaft 50a. During regular operation of hand-held power tool system 40a, a subregion 94a of eccentric element 34a bears against clamping band 28a and/or guard collar 64a that is located the shortest distance 96a away from rotational axis 92a.

If a tool 18a should burst during operation of hand-held power tool 12a, tool pieces are slung outwardly in a rotation direction 98a of tool 18a. If one of these tool pieces strikes guard unit 14a, the kinetic energy of the tool piece transferred to guard unit 14a exceeds the attachment energy of the frictional connection of closing unit 44a between guard unit 14a and hand-held power tool 12a. Guard unit 14a is then rotated out of its working position and in rotation direction 98a of tool 18a. Eccentric element 34a, which couples on surface 90a—which faces inward in radial direction 62a—of clamping band 28a and/or guard collar 64a in a non-positive manner, is rotated around rotation axis 92a in direction 100a, which is oriented in rotation direction 98a of tool 18a. Due to a motion of guard unit 14a, eccentric element 34a walks around clamping band 28a and/or guard collar 64, so that eccentric element 34a is moved together with guard unit 14a. In addition, it is also feasible for surface 90a—which faces inwardly in radial direction 62a—of clamping band 28a and/or guard collar 64a, and/or an outer surface of eccentric element 34a to have a high friction coefficient in order to increase a non-positive connection between eccentric element 34a and clamping band 28a and/or guard collar 64a due to a special material selection and/or a special surface treatment.

Due to the rotation of eccentric element 34a, a subregion 102a of eccentric element 34a that is located a greater distance 96a away from rotation axis 92a than is subregion 94a with shortest distance 96a, is rotated outwardly. As a result, cross-sectional area 22a of receiving flange 66a increases and a frictional force between receiving flange 66a and clamping band 28a—together with guard collar 64a—is increased. Kinetic energy transferred from the tool piece to guard unit 14a is partially absorbed by the acting frictional force, and, as soon as the frictional force reaches equilibrium with a residual impulse of guard unit 14a along rotation direction 98a, guard unit 14a is held in an anti-rotation lock position.

In a further embodiment of the present invention, it is feasible to increase the number of eccentric elements 34a and/or to change a location of eccentric element 34a within receiving flange 66a in a manner that appears reasonable to one skilled in the technical art.

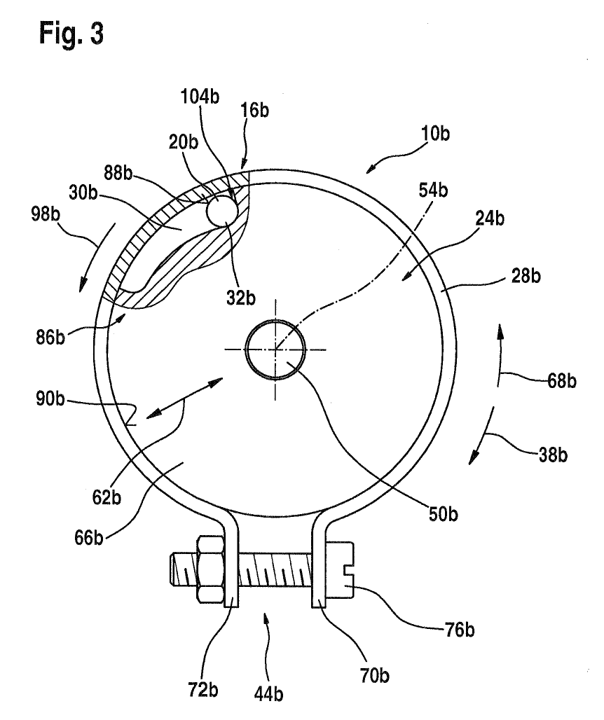

Alternative exemplary embodiments are shown in FIGS. 3 through 7b. Components, features, and functions that are essentially the same are labelled with the same reference numerals. To distinguish the exemplary embodiments from each other, the reference numerals of the exemplary embodiments are appended with the letters a through f. The description below is essentially limited to the differences from the exemplary embodiment in FIGS. 1 and 2. With regard for the components, features, and functions that remain the same, reference is made to the description of the exemplary embodiment in FIGS. 1 and 2.

FIG. 3 shows a schematic, partial cross-sectional view of an alternative guard anti-rotation lock device 10b of a hand-held power tool system. Guard anti-rotation lock device 10b includes a non-positive connection unit 16b with a non-positive connection element 20b, which is designed as a cylindrical rolling element 32b, and which is provided to prevent rotation between a not-shown hand-held power tool and a guard unit if a tool should burst. Non-positive connection unit 16b also includes a guide element 30b, in which rolling element 32b is movably supported. Guide element 30b is located in a receiving flange 66b in an edge region 86b—which is located outwardly in radial direction 62b—of receiving flange 66b, and it is tapered in design in a rotation direction 98b of a tool. Rolling element 32b is secured—in an expanded region 104b of guide element 30b via a not-shown release-prevention mechanism—against being moved in rotation direction 98b while the guard unit is changing position and/or when guard unit is removed. If a frictional force between rolling element 32b and a clamping band 28b and/or a guard collar exceeds a retaining force of the release-prevention mechanism, as occurs when the guard unit rotates in rotation direction 98b due to a transfer of kinetic energy of an outwardly slung piece of a burst tool, rolling element 32b is moved into an anti-rotation lock position along with the guard unit. An anti-rotation lock using non-positive connection element 20b is similar to that described with reference to FIG. 2.

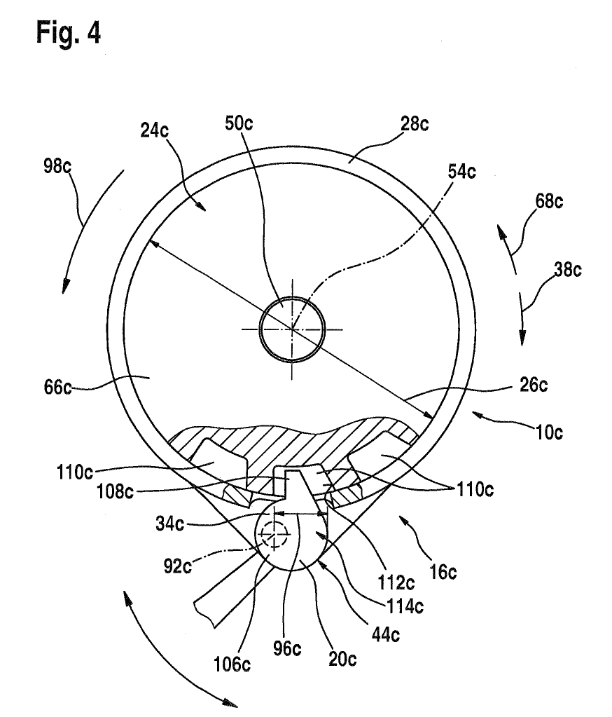

FIG. 4 shows a schematic, partial cross-sectional view of an alternative guard anti-rotation lock device 10c of a hand-held power tool system. Guard anti-rotation lock device 10c includes a non-positive connection unit 16c with a non-positive connection element 20c, which is designed as an eccentric element 34c, and which is provided to prevent rotation between a hand-held power tool and a guard unit if a tool should burst. Non-positive connection element 20c is provided to change a shape parameter—represented by a diameter 26c—of a component of the guard unit that is designed as clamping band 28c. Non-positive connection element 20c is also located on a closing unit 44c of the guard unit and, to this end, is designed as a single piece with a clamping closing element 106c. Eccentric element 34c also includes a hook element 108c, which, when the guard unit is in a working position, engages in one of several recesses 110c provided in a receiving flange 66c of the hand-held power tool in order to receive hook element 108c. When the guard unit is moved, together with eccentric element 34c, in a rotation direction 98c of the tool due to a piece of a burst tool striking the guard unit, hook element 108c is pressed against a wall 112c of recess 110c, eccentric element 34c is rotated around rotation axis 92c, and a subregion 114c of eccentric element 34c with a greatest distance 96c relative to rotation axis 92c is rotated in the direction of receiving flange 66c. This brings about a reduction in diameter 26c of clamping band 28c, which, in turn, results in hook element 108c being fixed more securely in position in recess 110c. An anti-rotation lock of the guard unit results from the non-positive connection, in a manner similar to that described with reference to FIG. 2.

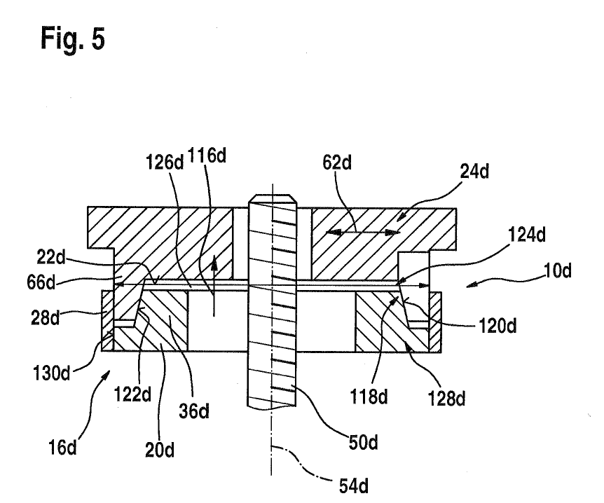

FIG. 5 shows an alternative guard anti-rotation lock device 10b of a hand-held power tool system, in a schematic, partial cross-sectional view. Guard anti-rotation lock device 10d includes a non-positive connection unit 16d with a non-positive connection element 20d, which is designed as a wedge element 36d, and which is provided to prevent rotation between a hand-held power tool and a guard unit if a tool should burst. Wedge element 36d is designed such that it tapers conically along a direction 116d, which extends essentially perpendicularly to a cross-sectional area 22d of a receiving flange 66d, on a region 118d that faces receiving flange 66d. In this region 118d, wedge element 36d includes—on a surface 120d that faces outwardly in radial direction 62d—a not-shown thread, via which wedge element 36d is located in a manner such that it may be screwed and unscrewed with a not-shown counter-thread on a surface 122d, which is located inwardly in radial direction 62d—of receiving flange 66d. To this end, receiving flange 66d includes a conically tapered recess 126d in a region 124d that faces inwardly in radial direction 62d. Wedge element 36d is designed cylindrical in shape in a region 128d facing away from receiving flange 66d. A diameter of wedge element 36d is essentially equal to an outer diameter of receiving flange 66d. In cylindrical region 128d of wedge element 36d, when the guard unit is in an installed working position, a clamping band 28d bears against a surface 130d that is oriented outwardly in radial direction 62d. A frictional force between surface 130d of wedge element 36d and clamping band 28d is greater than a frictional force between receiving flange 66d and clamping band 28d. If a tool should burst, and/or if the guard unit rotates in the direction of rotation of the tool, wedge element 36d is also rotated, due to a non-positive connection with clamping band 28d, and it is rotated into receiving flange 66d. A conically tapered design of wedge element 36d results in a widening of a cross-sectional area 22d of receiving flange 66d, which is designed slotted in the circumferential direction for this purpose, thereby preventing an irreversible deformation of receiving flange 66d. An anti-rotation lock of the guard unit results from the non-positive connection, in a manner similar to that described with reference to FIG. 2.

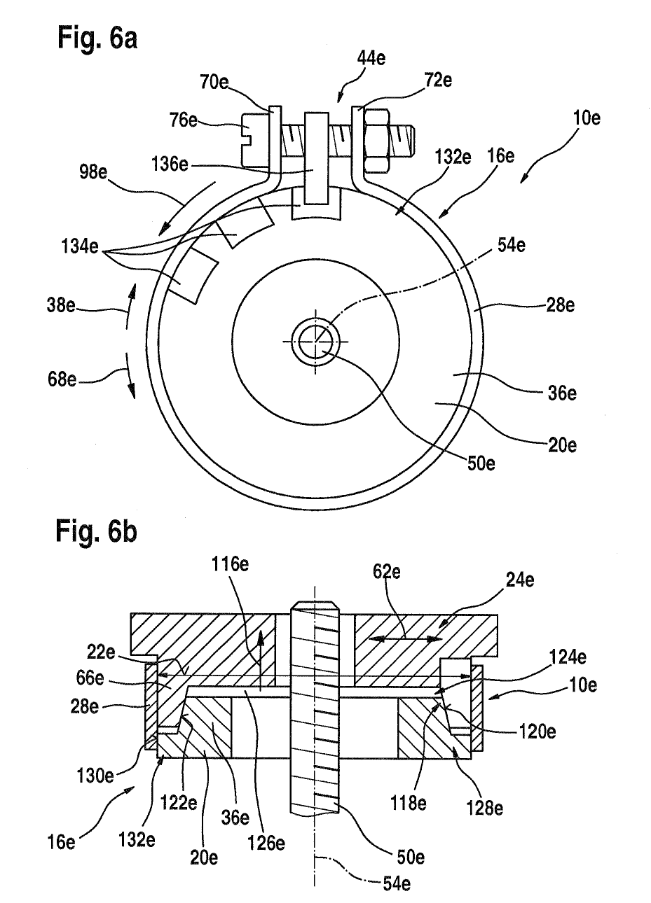

An alternative design of guard anti-rotation lock device 10e of a hand-held power tool system is shown in FIGS. 6a and 6b. Guard anti-rotation lock device 10e includes a non-positive connection unit 16e with a non-positive connection element 20e, which couples to a guard unit in a form-fit manner. To this end, non-positive connection element 20e designed as wedge element 36e includes—in an outer edge region 132e in radial direction 62e—a recess 134e that extends in circumferential direction 38e, 68e, in which a form-fit element 136e of the guard unit engages. Form-fit element 136e is located on a closing unit 44e of the guard unit, and it is designed as a tab-type hook element. Form-fit element 136e is brought into a form-fit position when the guard unit is attached and/or when closing unit 44e is closed in a non-positive manner using a clamping screw. An anti-rotation lock of the guard unit results from the non-positive connection, in a manner similar to that described with reference to FIG. 5.

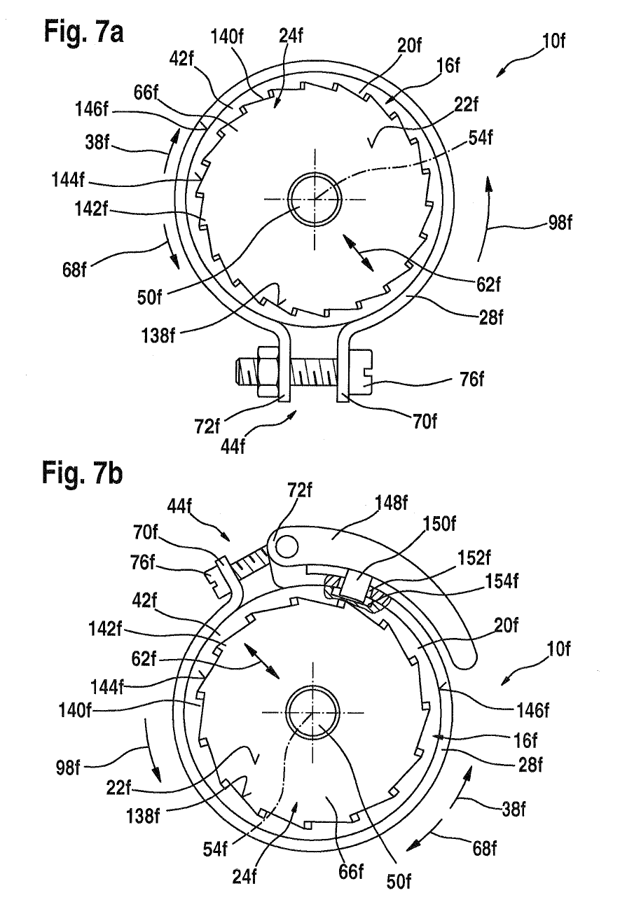

FIGS. 7a and 7b show a schematic, partial cross-sectional view of an alternative guard anti-rotation lock unit 10f of a hand-held power tool system. Guard anti-rotation lock device 10f includes a non-positive connection unit 16f with a non-positive connection element 20f, which is designed as an intermediate ring 42f, and which is provided to prevent rotation between a hand-held power tool and a guard unit if a tool should burst. Intermediate ring 42f is captively located on a receiving flange 66f of a receiving unit 24f. Intermediate ring 42f is designed in the shape of a ramp in a circumferential direction 38f, 68f on a surface 138f that is oriented inwardly in radial direction 62f and faces receiving flange 66f. To this end, intermediate ring 42f includes ramp elements 140f located one after the other in circumferential direction 38f, 68f, which engage in ramp elements 142f—that have the same shape but face in opposite directions—on a surface 144f—that is oriented outwardly in radial direction 62f—of receiving flange 66f. When the guard unit is installed in a working position, a surface 146f—that is oriented outwardly in radial direction 62f—of intermediate ring 42f couples in a non-positive manner with a clamping band 28f and/or a guard collar of the guard unit (FIG. 7a). If a tool should burst, or if the guard unit rotates in rotation direction 98f of the tool, intermediate ring 42f is also rotated, due to a frictional force between clamping band 28f and intermediate ring 42f, and ramp elements 140f, 142f of intermediate ring 42f and receiving flange 66f are displaced toward each other. A diameter of intermediate ring 42f is thereby widened, and/or a cross-sectional area 22f of receiving unit 66f enlarges, together with intermediate ring 42f, thereby resulting in an effective anti-rotation lock between the guard unit and receiving unit 24f due to a non-positive connection similar to that described with reference to FIG. 2.

In FIG. 7b, intermediate ring 42f couples in a form-fit manner with clamping band 28f for driving in a rotary manner if the guard unit should rotate due to a tool bursting. To this end, a closing element 148f designed as a clamping lever includes a cam 150f, which, in a closed state, extends inwardly on the clamping lever in radial direction 62f away from a closing unit 44f designed as a toggle joint system. For driving in a form-fit, rotary manner, clamping band 28f and intermediate ring 42f each include a recess 152f, 154f, through and/or in which cam 150f engages when the toggle joint system is in the closed state. An anti-rotation lock using intermediate ring 42f and a further embodiment of intermediate ring 42f is referenced in the description of FIG. 7a.

What is claimed is:

1. A guard anti-rotation lock device for a hand-held power tool (12a-f), in particular for an angle grinder, which is provided to prevent rotation between the hand-held power tool (12a-f) and a guard unit (14a-f), characterized by a non-positive connection unit (16a-f), which is provided to prevent rotation between the hand-held power tool (12a-f) and the guard unit (14a-f) if a tool (18a-f) should burst.

2. The guard anti-rotation lock device as recited in claim 1, wherein
the non-positive connection unit (16a-f) is provided to establish a non-positive connection between the hand-held power tool (12a-f) and the guard unit (14a-f) by changing at least one shape parameter of at least one component of the hand-held power tool (12a-b; 12d-f) and/or the guard unit (14c).

3. The guard anti-rotation lock device as recited in claim 1, wherein
the non-positive connection unit (16a-f) includes at least one non-positive connection element (20a-f), which is provided to change the shape parameter of the hand-held power tool (12a-b; 12d-f) and/or the guard unit (14c).

4. The guard anti-rotation lock device as recited in claim 2, wherein
the shape parameter includes a cross-sectional area (22a-b, 22d-f) of a receiving unit (24a-b; 24d-f) of the hand-held power tool (12a-b; 12d-f) and/or a diameter (26c) of a clamping band (28c) of the guard unit (14c).

5. The guard anti-rotation lock device as recited in at least claim 3, wherein
the non-positive connection element (20a-f) is movably supported on the hand-held power tool (12a-b; 12d-f) and/or on the guard unit (14c).

6. The guard anti-rotation lock device as recited in claim 5, wherein
the non-positive connection element (20a-f) is movable—together with the guard unit (14a-f) into an anti-rotation lock position if a tool (18a-f) should burst.

7. The guard anti-rotation lock device as recited in claim 5, wherein
the non-positive connection unit (16b) includes a guide element (30b), in which the non-positive connection element (20b) is movably supported.

8. The guard anti-rotation lock device as recited in claim 6, wherein
the non-positive connection element (20a; 20b; 20d; 20f) is provided to couple in at least partially form-fit manner to the guard unit (14a; 14b; 14d; 14f).

9. The guard anti-rotation lock device as recited in claim 6, wherein
the non-positive connection element (20c; 20e; 20f) is provided to couple in at least partially non-positive manner to the guard unit (14e; 14f).

10. The guard anti-rotation lock device as recited in claim 3, wherein
the non-positive connection element (20a; 20b) is designed as a rolling element (32a; 32b).

11. The guard anti-rotation lock device as recited in claim 3, wherein
the non-positive connection element (20a; 20c) is designed as an eccentric element (34a; 34c).

12. The guard anti-rotation lock device as recited in claim 3, wherein
the non-positive connection element (20d; 20e) is designed as a wedge element (36d; 36e).

13. The guard anti-rotation lock device as recited in claim 12, wherein
the wedge element (36d; 36e) includes a thread that enables attachment to a receiving unit (25d; 24e) of the hand-held power tool (12d; 12e).

14. The guard anti-rotation lock device as recited in claim 3, wherein
the non-positive connection element (20f) is designed in the manner of a ramp in a circumferential direction (38f).

15. A hand-held power tool system with a hand-held power tool (12a-f), in particular an angle grinder, a guard unit (14a-f), and a guard anti-rotation lock device (10a-f) as recited in one of the preceding claims, wherein
the guard anti-rotation lock device (10a-f) includes a non-positive connection unit (16a-f), which is provided to prevent rotation between the hand-held power tool (12a-f) and the guard unit (14a-f) if a tool (18a-f) should burst.

16. The hand-held power tool system as recited in claim 15, wherein
the non-positive connection unit (16a-f) includes at least one non-positive connection element (20a-f), which is provided to change a shape parameter of the hand-held power tool (12a-f) and/or the guard unit (14a-f).

17. The hand-held power tool system as recited in claim 15, wherein
the hand-held power tool (12a-b, 12d-f) includes a receiving element (24a-b; 24d-f), in which the non-positive connection element (20a-b; 20d-f) is at least partially supported.

18. The hand-held power tool system as recited in claim 17, wherein
the receiving unit (24d; 24e) is designed slotted at least partially along a circumferential direction (38d; 38e).

19. The hand-held power tool system as recited in claim 17, wherein
the receiving unit (38f) includes an intermediate ring (42f) on which the non-positive connection element (20f) is at least partially located.

20. The hand-held power tool system as recited in claim 15, wherein
the guard unit (14c) includes at least one closing unit (44c), on which the non-positive connection element (20c) is at least partially located.
